(19) United States
(12) Patent Application Publication
(10) Pub. No.: US 2019/0275768 A1
(43) Pub. Date: Sep. 12, 2019

(54) EXTERIOR LAMINATED VENEER WOOD DECK SYSTEM

(71) Applicant: LOUISIANA-PACIFIC CORPORATION, Nashville, TN (US)

(72) Inventor: GARETH PAUL MERRICK, GIG HARBOR, WA (US)

(21) Appl. No.: 16/297,123

(22) Filed: Mar. 8, 2019

Related U.S. Application Data
(60) Provisional application No. 62/640,080, filed on Mar. 8, 2018.

(51) Int. Cl. B32B 21/14; E04F 15/04; E04F 15/02

(52) U.S. Cl. CPC B32B 21/14; B32B 2250/05; E04F 15/02183; E04F 15/04

(57) ABSTRACT

A system for constructing a deck using laminated veneer wood products, including, but not limited to, laminated veneer decking (LVD). LVD is comprised of multiple layers of wood and other materials, including, but not limited to, non-wood polymer-based materials, thereby providing specific engineered properties to the product. Each veneer layer can be differentially treated with chemicals, biocides, and other additives, depending on the wood species and position of the veneer in the LVD. Similarly, adhesives used in the formation of each veneer may be differentially treated with chemicals, biocides, and other additives. Adhesives used for secondary bonding of veneer layers to form the LVD also may be similarly differentially treated.

This application claims priority to U.S. Provisional App. No. 62/640,080, filed Mar. 8, 2018, which is incorporated herein by specific reference for all purposes.

### FIELD OF INVENTION

This invention relates to a system for an exterior deck comprising laminated veneer wood components.

### BRIEF DESCRIPTION OF THE DRAWINGS

FIG. 1 shows views of an exterior laminated veneer decking system.

### DETAILED DESCRIPTION OF EXEMPLARY EMBODIMENTS

In various exemplary embodiments, the present invention comprises a system for constructing a deck 2 using laminated veneer wood products, including, but not limited to, laminated veneer decking (LVD). LVD is comprised of multiple layers of wood and other materials, including, but not limited to, non-wood polymer-based materials, thereby providing specific engineered properties to the product.

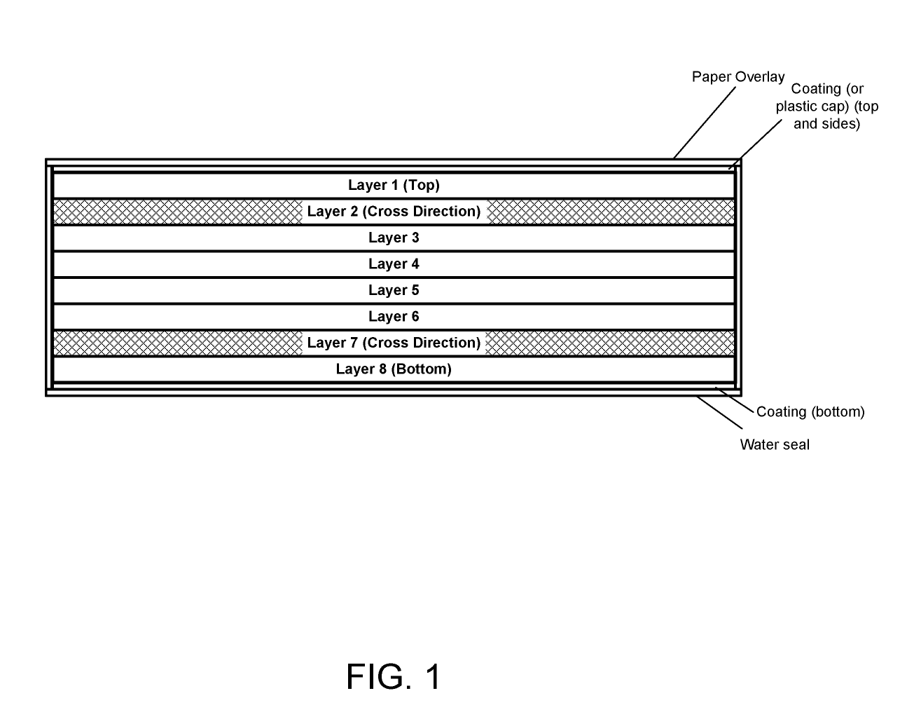

In one exemplary embodiment, as seen in FIG. 1, an assembled LVD board comprises a core with or between a top surface, bottom surface, and edges. The core may comprise solid wood, laminated veneer lumber (LVL), or an engineered wood composite, or combinations thereof. The core may comprise one or more veneers of varying thickness, grain orientation, and/or wood species, separately or in combination.

Examples of wood species include, but are not limited to, oak, teak, ipe, red cedar, redwood, cypress, spruce, pine, and douglas fir. Engineered wood composites include, but are not limited to, laminated strand lumber (LSL), oriented strand board (OSB), or oriented strand lumber (OSL).

The wood or other core components may be dyed (for color or patterning), and/or treated with one or more chemical agents, either during manufacture, prior to assembly, or after assembly (e.g., as individual components or in final laminate form), to provide protection from UV or light, fungal decay, insects, fire, and/or moisture. While all layers may be treated identically, this is not required, and different layers may be targeted with the type of chemical treatment appropriate for that layer, thereby optimizing performance while limiting costs. Examples of various chemical and other treatments are disclosed in Horton, U.S. Pat. No. 7,544,423, and Parker, U.S. Pub. No. 2014/0356632, both of which are incorporated herein in their entireties by specific reference for all purposes.

In several embodiments, non-wood reinforcement layers may be added, including, but not limited to, fiberglass, Kevlar, or similar materials. These may be added anywhere in the product, including, but not limited to, between the layers of wood, composite wood, and/or veneer.

Wood layers, papers, polymer and reinforcement layers are bonded together with existing or custom resin blends. These resins react to form bonds between all layers under heat and pressure typical to LVL or composite wood manufacturing. The resins and adhesives used to form a single veneer layer (i.e., to bond the parts or strips that form a layer), as well as those used to bond layers, may be treated with various chemical, biocidal, and other treatments or additives as discussed above. Resins may be uniquely formulated to bond wood that has higher moisture contents, preservatives, or other modifications to the layers. Examples of resin adhesives and additives are disclosed in Hsu, U.S. Pat. No. 5,246,652; Stark, U.S. Pat. No. 8,691,340; Stark, U.S. Pat. No. 9,878,464; Jaetsch, U.S. Pub. No. 2001/0027217; Romero Amaya, U.S. Pub. No. 2007/0074640; and Cornfield, PCT/GB96/00511 (WO 9627483); all of which are incorporated herein in their entireties by specific reference for all purposes.

The top surface and edges (i.e., three sides of the decking product) may comprise a polymer (or similar material) cap or a proprietary coating, including, but not limited, polyethylene or a resin-impregnated densified overlay paper. The top surface may be finished in any desired aesthetic or functional manner, including, but not limited to, a smooth finish, a slip resistant textured finish, or an embossed/printed wood grain finish.

The long axis edges of the decking product may be similarly finished, and include one or more recessed grooves to accommodate a mechanical fastening system.

In contrast to the prior art, which require thicker laminates (e.g., ¼″ or above), the present invention provides for thinner laminates or layers. In some exemplary embodiments, layer thickness are ⅛″ to 1/10″ or less, depending on the wood species and the placement or position of the layer in the product. The present invention thus achieves effective penetration of the chemicals or other additives in and on the layer with lower pressure or no pressure than in the prior art.

In addition, the prior art uses dry veneer, i.e., less than 15% moisture content. This is the standard to dry softwood lumber to, and also prevents mold growth on the wood substrate (yellow pine is particularly prone to this). In several embodiments, however, the present invention uses resin or adhesive systems that work with wetter laminates (i.e., greater than 15% moisture content). This provides the advantage of the product being processed at a moisture content closer to the moisture content at which it will acclimate in use, with less dimensional change and resulting distortion, cracking, de-lamination, warping or similar effects.

In several embodiments, the present invention provides for a combination, synergistic approach combining differential treatment of the layers as well as differential treatment of adhesives (i.e., different additives or chemicals are used in the adhesives in different veneer layers, and in different adhesives between different veneer layers). Thus, for example, a low molecular weight resin (such as one based on isocyanate) may be used for some of the adhesives, but not other.

A number of the biocides and other treatments disclosed in the prior art are organic, and thus have limited end use application and often are not capable of surviving a hot press process (i.e., rendered biocidally inactive). In addition, they may also be bound within the cured polymer, and thus are not fully bio-available to protect against insects, fungi, or the like.

Accordingly, in one embodiment the present invention comprises an LVL product with veneers as described above, including biocides that are heat stable (such as copper or boron-based inorganic actives). The veneers are bonded with an adhesive that is dosed with a different or the same biocide (in some cases with additional additives suitable to the end use) (i.e., glue-line treatment). The protection afforded by the biocide and/or other additives from the glue-line treatment is supplemental to the protection delivered by treating the veneer layers directly.

In a further embodiment, a hot press is not used to bond the veneer layers (i.e., secondary bonding). Instead, suitable hot melt polyurethane-based adhesives, or similar substances that form structural bonds under room-temperature assembly line conditions are used. The veneer treatment process itself may use a heated cure step or a moisture exposure curing step. The added moisture would be beneficial in driving the cure rate of the polyurethane hot melt adhesive (or similar substances) for secondary bonding of the treated veneers into LVL. These hot melt adhesives do not require high heat or high pressure to bond the LVL assembly, and when cured, provide a barrier to exterior moisture absorption and movement within the LVL product.

In some embodiments, negative pressure (or vacuum) at low levels and/or low duration may also be used during the veneer treatment to enhance the efficiency and effectiveness of the treatment process, prior to secondary bonding of the treated veneers into LVL.

The species of wood used may be optimized by location to impart target performance characteristics. An integral protective top layer, for example, may provide UV, moisture resistance, and fire resistance. For another example, the outer visible layers or veneers may be selected for desired aesthetic properties (e.g., a tropical hardwood, such as Brazilian ipe). Outer layers may also be selected for inherent natural durability or weather resistance (e.g., cedar or redwood, which are recognized as naturally durable). Outer or exterior layers also may be selectively treated with a fire resistant treatment or agent to impart fire resistance properties (and thereby be in compliance with applicable building codes), and/or may be selected from wood species known to have natural resistance to fire and, through testing, have been demonstrated to meet with applicable codes.

Accordingly, the present invention leverages the treated properties and inherent mechanical strength, dimensional stability, and split resistance of LVL combined with the ability to optimize aesthetic, preservative, and fire resistance properties of substrates. The present invention further demonstrates unique functionality of the above-described substrate in combination with non-wood polymer-based enhancements, such as those used with wood-plastic composite decking. The invention thus avoids the significant limitations of prior art decking (monolithic/dimensional wood or wood composites): e.g., pressure-treated solid sawn lumber is prone to splitting, checking, warping and UV damage (thereby requiring significant maintenance labor and expense as well as resulting in a short service life), while wood-plastic composites are relatively expense and typically require additional support framing to prevent creep under load, especially at higher temperatures.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A laminated veneer deck board, comprising:
a core comprising a plurality of veneer layers, wherein adjacent veneer layers are bonded by one or more adhesives, and further wherein at least two of said plurality of veneer layers differ in thickness, grain orientation, and/or wood species;
wherein said plurality of veneer layers are differentially treated with one or more chemical agents based at least in part on the position of the veneer layer in the core, so that at least two of said plurality of veneer layers are treated with different chemical agents;
further wherein the adhesives between said plurality of veneer layers are differentially treated with one or more chemical agents.

2. The laminated veneer deck board of claim 1, wherein said plurality of veneer layers are differentially colored.

3. The laminated veneer deck board of claim 1, further comprising at least one reinforcement layer.

4. The laminated veneer deck board of claim 3, wherein said at least one reinforcement layer is not wood based.

5. The laminated veneer deck board of claim 3, wherein said at least one reinforcement layer comprises fiberglass or Kevlar.

6. The laminated veneer deck board of claim 1, wherein the bonding of the plurality of veneer layers does not require heat.
